(19) United States
(12) Patent Application Publication
(10) Pub. No.: US 2024/0392907 A1
(43) Pub. Date: Nov. 28, 2024

(54) COUPLING SYSTEM FOR GLUE HOSES AND METHOD FOR OPERATING A GLUING MACHINE

(71) Applicant: Krones Aktiengesellschaft, Neutraubling (DE)

(72) Inventors: Markus GABLER, Rohrdorf – Thansau (DE); Rainer NIEDERMAIER, Kolbermoor (DE); Florian HILLE, Obing (DE); Christian CANALICCHIO, Bad Endorf (DE); Simon VOCKENSPERGER, Rosenheim (DE); Thomas STADLER, Kolbermoor (DE); Martin DIETERSBERGER, Grosskarolinenfeld (DE)

(21) Appl. No.: 18/667,617

(22) Filed: May 17, 2024

(30) Foreign Application Priority Data
May 26, 2023 (DE) 10 2023 113 975.4

(51) Int. Cl. F16L 39/02; B05C 5/00; B05C 11/10

(52) U.S. Cl. CPC F16L 39/02; B05C 5/001; B05C 11/1015

(57) ABSTRACT

The invention relates to a coupling system (1) for fluid connection of glue hoses (5, 5′, 15, 15′). The coupling system (1) comprises a housing (40) and at least one coupling piece (6, 6′) that can be fastened to a glue hose (15, 15′) of a gluing device (72), is received by the housing (40), and can be selectively and in each case detachably coupled to mating coupling pieces (8, 8′) of several glue hoses (5, 5′) of different glue application format parts so that a fluid connection is formed between the corresponding glue hose (15, 15′) of the gluing device and the corresponding further glue hose (5, 5′) of the corresponding glue application format part via the coupling piece (6, 6′) and the mating coupling piece (8, 8′) coupled to the coupling piece (6, 6′).

### CLAIM OF PRIORITY

The present application claims priority to German Application DE 10 2023 113 975.4 filed May 26, 2023, which is incorporated by reference.

### FIELD OF THE INVENTION

The present invention relates to a coupling system, to a gluing machine and to a method for operating such a gluing machine.

### BACKGROUND OF THE INVENTION

When handling articles such as beverage containers or the like, gluing devices are used in practice that can apply glue by corresponding application heads in order to achieve fixation by the glue application. The glue is fed from the corresponding gluing device to the corresponding application head via a corresponding hose connection.

A gluing device that can supply cold glue to an application head via an appropriately designed hose connection is already known from the German utility model specification DE 20 2014 100 123 U1. This known gluing device is designed as a rotary vane pump for pumping glue. The rotary vane pump comprises a rotor that has at least two intersecting vanes. Furthermore, a stator is provided whose effective cross section deviates from a circular shape in such a way that the vanes should have a maximum clearance of two millimeters in the direction of displacement, regardless of the pivot bearing of the rotor.

If a machine in which such a gluing device is used comprises a plurality of different glue application format parts via each of which glue can be applied, such glue application format parts are fluidically coupled to the gluing device by a corresponding fixed hose connection. In practice, gluing devices have a limited number of connections so that several gluing devices are often required if the machine has a plurality of different glue application format parts.

The corresponding hoses needed to feed a plurality of different glue application format parts and the several different gluing devices require a lot of space that is often not available.

One object of the invention can therefore be seen in providing a means by which the aforementioned problems can be at least partially avoided.

The above object is achieved by the subject matter that comprises the features in the independent claims. Further advantageous embodiments are described by the dependent claims.

### SUMMARY OF THE INVENTION

The invention relates to a coupling system for fluid connection of glue hoses. The coupling system comprises a housing and at least one coupling piece that can be fastened to a glue hose of a gluing device, is received by the housing, and can be selectively and detachably coupled to mating coupling pieces of several further glue hoses of different glue application format parts so that a fluid connection is formed between the corresponding glue hose of the gluing device and the corresponding further glue hose of the corresponding glue application format part via the coupling piece and the mating coupling piece coupled to the coupling piece.

In practice, it is thus possible to couple several further glue hoses of several different glue application format parts to a particular coupling piece of the coupling system one after the other and selectively and detachably via corresponding mating coupling pieces, so that a fluid connection is formed between the corresponding glue hose (or the supply line for glue) of the gluing device and the corresponding further glue hose of the corresponding glue application format part via the coupling piece and the mating coupling piece coupled to the coupling piece.

It is therefore no longer absolutely necessary to provide several gluing devices to be able to supply glue to a plurality of different glue application format parts. The coupling system makes it easy and uncomplicated to switch between a plurality of different glue application format parts when different glue application format parts are required for glue application. The coupling system allows a gluing machine to be designed in a cost-effective and space-saving way.

Embodiments have proven successful in which the at least one coupling piece forms a coupling body into which a corresponding mating coupling piece designed as a plug can be inserted for the corresponding coupling. Such embodiments allow for quick and easy connection between the corresponding coupling piece and the corresponding mating coupling piece. In this case, it is conceivable that the at least one coupling piece comprises an actuating sleeve that is mounted on the coupling body so as to be movable in the axial direction in order to release a coupling formed between the at least one coupling piece and the mating coupling piece.

In this case, in various embodiments, it is possible for the actuating sleeve to receive the coupling body at least in some regions or for the actuating sleeve to extend radially around the coupling body.

Alternatively or additionally, it is possible for the at least one coupling piece to comprise several locking balls by which the mating coupling piece designed as a plug is automatically locked to the coupling body when the corresponding mating coupling piece designed as a plug is inserted into the coupling body. If the at least one coupling piece additionally comprises the aforementioned actuating sleeve, it is possible for the at least one coupling piece to be designed in such a way that a lock formed via the several locking balls can be released by moving the actuating sleeve in the axial direction.

In these described embodiments or also in the general context, it is possible that the at least one coupling piece is designed in such a way that the at least one coupling piece automatically locks the corresponding mating coupling piece designed as a plug upon insertion into the coupling body.

It is also possible for the coupling system to comprise at least one heating element for controlling the temperature of the at least one coupling piece, wherein the at least one heating element is received in the housing. The at least one heating element can be at least one heating cartridge. Alternatively or additionally, the at least one heating element can be formed by at least one electrically operable heating element. Thus, in various embodiments, glue can be heated via the at least one coupling piece and exit the coupling system as hot glue. In practice, a reasonably manageable temperature of hot glue exiting the coupling system can range from about 130° C. to temperatures of about 190° C.

The housing can be formed from at least two corresponding parts that receive the at least one coupling piece inaccessibly from the outside when the at least two corresponding parts are joined together. Further, the at least two corresponding parts can be separable in such a way that the at least one coupling piece can be accessed by separating the at least two corresponding parts or that a user can access the at least one coupling piece by separating the at least two corresponding parts.

Alternatively or additionally, the coupling system can comprise a locking mechanism for locking the at least two corresponding parts when they are joined together. The locking mechanism can be operated to release the lock. In this context, embodiments in which the locking mechanism is a bolt/cylinder unit have proven to be successful. The bolt/cylinder unit can sit on the housing or on one of the at least two corresponding parts of the housing.

The invention also relates to a gluing machine. This gluing machine can in particular and preferably be designed to carry out each of the embodiments of the method according to the invention described below.

The gluing machine according to the invention comprises at least one gluing device having at least one glue hose. Furthermore, the gluing machine comprises several glue application format parts having a corresponding further glue hose, each of the several glue application format parts being designed for applying glue to containers and/or packaging for containers. The several glue application format parts can be application heads that can apply glue to containers and/or packaging for containers by spraying glue onto containers and/or packaging.

The several glue application format parts can also be several glue rollers, which several glue rollers can apply glue to containers and/or packaging for containers in that the several glue rollers each rotate and are in surface contact with the containers and/or packaging.

It is provided that the gluing machine comprises at least one coupling system having a housing and at least one coupling piece, which at least one coupling piece is received by the housing and is fluidically connected to the at least one glue hose of the at least one gluing device. The coupling system can be designed in accordance with the previously described embodiments, without reference being made again to the embodiments already described.

The several further glue hoses of the several glue application format parts in each case comprise a mating coupling piece. The at least one coupling piece can be selectively and detachably coupled to the mating coupling pieces of the other glue hoses so that a fluid connection is formed between the corresponding glue hose of the gluing device and the corresponding other glue hose of the corresponding glue application format part via the coupling piece and the mating coupling piece coupled to the coupling piece.

In the case of the gluing machine, it is also possible that the at least one coupling piece forms a coupling body and the mating coupling pieces are designed as plugs that can be inserted into the coupling bodies for the corresponding coupling with the coupling body.

It has also proved useful in the case of the gluing machine if the at least one coupling piece is designed in such a way that the at least one coupling piece automatically locks the corresponding mating coupling piece designed as a plug upon insertion into the coupling body.

It is also possible for the coupling system to comprise at least one heating element for controlling the temperature of the at least one coupling piece, wherein the at least one heating element is received in the housing of the coupling system. The at least one heating element can be at least one heating cartridge.

Embodiments in which the gluing machine has a locking mechanism to lock the housing have also proven successful. The locking mechanism of the gluing machine can also be a bolt/cylinder unit.

The gluing machine can comprise at least one temperature sensor for determining an actual temperature of the at least one coupling piece, wherein the at least one temperature sensor and the locking mechanism are operatively connected to one another so that a release of a lock produced via the locking mechanism is prevented if the particular actual temperature determined via the temperature sensor is above a predefined target temperature.

The gluing machine can also comprise a control device which is connected to the at least one temperature sensor and the locking mechanism and can detect or determine a respective actual temperature of the at least one coupling piece via the at least one temperature sensor. Information on the predefined target temperature can be stored on the control device. Furthermore, the control device can be designed in such a way that it prevents a lock produced by the locking mechanism from being released if the respective actual temperature determined or detected by the at least one temperature sensor is above a predefined target temperature.

In the case of the gluing machine, the coupling system can be arranged within a defined safety zone of the gluing machine and comprise at least one safety sensor by which the presence of a person in the safety zone can be detected. The at least one safety sensor and the gluing device can be operatively connected to one another in such a way that the glue is prevented from being conveyed by the gluing device when the presence of a person in the safety zone is detected by the at least one safety sensor.

A control device can be provided that is connected to the at least one safety sensor and the gluing device. The control device can be designed in such a way that it automatically prevents glue from being conveyed by the gluing device when the control device detects the presence of a person in the safety zone by the at least one safety sensor. The at least one safety sensor can be, for example, a camera whose field of view extends across the safety zone. The at least one safety sensor can also be a touch sensor that detects the opening of a door that allows a person to access the safety zone.

The invention also relates to a labeling apparatus for beverage containers, which labeling apparatus comprises a gluing machine according to an exemplary embodiment of the foregoing description.

The invention also relates to a packer for beverage containers, which packer comprises a gluing machine according to an exemplary embodiment of the foregoing description.

The invention also relates to a method for operating the gluing machine. The gluing machine comprises a gluing device having at least one glue hose and has a coupling system having a housing in which at least one coupling piece is located that is attached to the at least one glue hose. In addition, several different glue application format parts are provided in the method, each of which has a further hose connection having a corresponding mating coupling piece, wherein the coupling piece can be selectively and detachably coupled to the mating coupling pieces so that a fluid connection is formed between the corresponding glue hose of the gluing device and the corresponding further glue hose of the corresponding glue application format part via the coupling piece and the mating coupling piece coupled to the coupling piece.

The method comprises at least the following steps, which, however, are not intended to be exhaustive:
selecting a particular glue application format part from the several different glue application format parts and
coupling the coupling piece to the mating coupling piece of the further hose connection of the selected glue application format part, which is accompanied by a fluid connection being formed between the corresponding glue hose of the gluing device and the corresponding further glue hose of the corresponding selected glue application format part via the coupling piece and the mating coupling piece coupled to the coupling piece.

In various embodiments, the coupling system can have a locking mechanism by which the housing is locked. Furthermore, a particular actual temperature of the coupling piece can be determined via a temperature sensor, wherein the temperature sensor and the locking mechanism interact so that the locking is maintained when the actual temperature is above a predefined target temperature.

It is possible that the method is implemented or carried out using one of the embodiments of the gluing machine according to the invention already described above.

At this point, it should also be emphasized that features that have been described above for embodiments of the coupling system according to the invention can also relate to, or be, partial aspects of the method according to the invention and of the gluing machine according to the invention. Therefore, if the description or the claim definitions make mention of an embodiment of the coupling system according to the invention, this applies equally to the embodiments of the method according to the invention and of the gluing machine according to the invention.

The same applies vice versa, such that all aspects and embodiment variants that have been explained in conjunction with embodiments of the method according to the invention or of the gluing machine according to the invention can also relate to, or be, partial aspects of the coupling system according to the invention. Therefore, if the description or the claim definitions pertaining to the method or to the gluing machine make mention of particular aspects or effects, this applies equally to the embodiments of the coupling system according to the invention. It is also possible that various embodiments of the method according to the invention are implemented or carried out by an embodiment of the coupling system according to the invention or by an embodiment of the gluing machine according to the invention.

### BRIEF DESCRIPTION OF THE FIGURES

Exemplary embodiments of the invention and their advantages are explained in more detail below with reference to the accompanying figures. The proportions of the individual elements relative to one another in the figures do not always correspond to the actual proportions, since some forms are simplified, while other forms are shown enlarged in relation to other elements for better illustration.

FIG. 1 is a schematic perspective view of an embodiment of a coupling system according to the invention and illustrates steps as may be provided in various embodiments of the method according to the invention.

FIG. 2 shows the embodiment of a coupling system according to FIG. 1, illustrating further aspects.

FIG. 3 shows the embodiment of a coupling system according to FIGS. 1 and 2 with a closed and locked housing.

FIG. 4 shows the embodiment of a coupling system according to FIGS. 1 to 3 with a closed housing from a further position.

FIG. 5 shows an embodiment of a packer with an embodiment of a gluing machine according to the invention.

### DETAILED DESCRIPTION OF THE INVENTION

Identical reference numerals are used for identical elements of the invention or those having the same effect. Furthermore, for the sake of clarity, only reference signs are shown in the individual figures, which are required for the description of the respective figure. The illustrated embodiments are merely examples of how the invention can be designed, and are non-limiting.

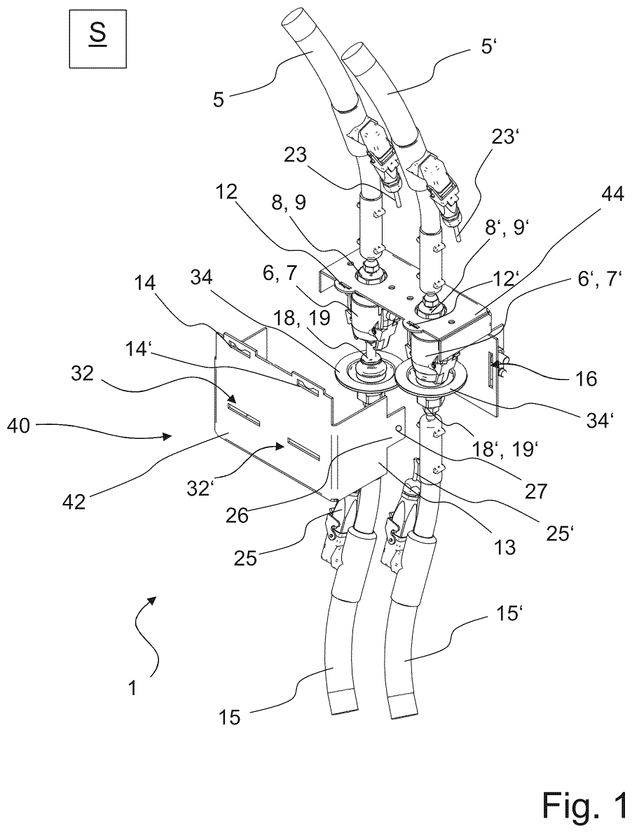

FIG. 1 is a schematic perspective view of an embodiment of a coupling system 1 according to the invention and illustrates steps as may be provided in various embodiments of the method according to the invention.

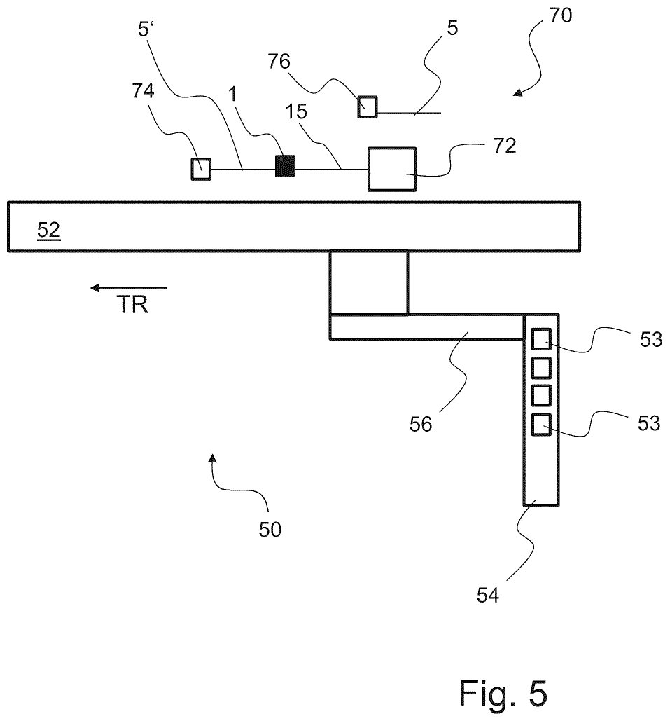

In order to supply glue to glue application format parts 74 and 76 (cf. FIG. 5), which can be formed for example by spray heads, it is provided in apparatuses known from the prior art that the corresponding glue application format parts 74 and 76 are firmly connected to a gluing device 72 by hose connections.

Depending on the particular application process, different glue application format parts 74 or 76 or different spray heads may be required, which are adapted to the particular application process and are supplied with glue via a gluing device 72 depending on the application process. For this reason, in practice, several gluing devices 72 are often kept ready, which gluing devices are permanently connected to a plurality of different spray heads in order to be able to switch between different spray heads.

Gluing machines that comprise several gluing devices 72 to supply a plurality of spray heads with glue require a lot of space. With the coupling system 1, as described in the exemplary embodiment according to FIGS. 1 to 4 and shown in FIG. 5 as part of a packer 50, less space is required when different spray heads are needed for different application processes. In addition, a smaller number of gluing devices 72 is required, so that an economically advantageous embodiment of a gluing machine 70 can also be provided by the coupling system 1.

With the coupling system 1, the glue hoses 5 and 5′ can be fluidically connected to the other glue hoses 15 and 15′. The glue hoses 15 and 15′ lead from the coupling system 1 to a gluing device 72 (cf. FIG. 5) or to a glue pump and are firmly connected to the gluing device 72 or to the glue pump. Such a gluing device can have several outlets for glue, so that glue can be pumped through the two glue hoses 15 and 15′ via a common gluing device 72 or via a common glue pump. In the present case, the two glue hoses 15 and 15′ are each fluidically coupled to a common gluing device 72 or to a common glue pump.

The other glue hoses 5 and 5′ each lead from the coupling system 1 to a glue application format part 74 or 76 (cf. FIG. 5), which is not shown in FIGS. 1 to 4 for reasons of clarity. The glue application format parts can be, for example, spray heads of a labeling apparatus. Each spray head or each glue application format part is assigned its own further glue hose 5 or 5′, via which the corresponding spray head or the corresponding glue application format part is supplied with glue.

In order to establish a fluid connection between the glue hoses 15 and 15′ and the further glue hoses 5 and 5′, the coupling system 1 comprises two coupling pieces 6 and 6′, which are designed as coupling bodies 7 and 7′. At one end region, a mating coupling piece 18 or 18′ is attached to each of the glue hoses 15 and 15′, which lead from a gluing device 72 or a glue pump to the coupling system 1, which corresponding mating coupling piece 18 or 18′ is designed as a plug 19 or 19′.

The mating coupling pieces 18 or 18′ are inserted into the coupling pieces 6 or 6′ so that a corresponding mating coupling piece 18 or 18′ is firmly connected to a corresponding coupling piece 6 or 6′. The corresponding coupling piece 6 or 6′ comprises several locking balls that automatically lock the corresponding mating coupling piece 18 or 18′ to the coupling piece 6 or 6′ when a corresponding mating coupling piece 18 or 18′ is inserted into the coupling piece 6 or 6′.

Mating coupling pieces 8 and 8′, each designed as plugs 9 and 9′, are also attached to ends of the further glue hoses 5 and 5′, which lead from a corresponding spray head to the coupling system 1. The mating coupling pieces 8 or 8′ are also inserted into the coupling piece 6 so that a corresponding mating coupling piece 8 or 8′ is firmly connected to a corresponding coupling piece 6 or 6′.

When both the mating coupling pieces 18 and 18′ attached to the glue hoses 15 and 15′ and the mating coupling pieces 8 and 8′ attached to the further glue hoses 5 and 5′ have been inserted into the coupling bodies 6 and 6′, the glue hoses 15 and 15′ are fluidically connected to the further glue hoses 5 and 5′. In this way, glue can be conveyed from the glue hoses 15 and 15′ to the further glue hoses 5 and 5′ via the coupling pieces 6 and 6′ and the mating coupling pieces 8 and 8′ or 18 and 18′.

A heating connection 23 and 23′ or 25 and 25′ is assigned to each glue hose 15 and 15′ and each further glue hose 5 and 5′. A heating element can be supplied with electrical energy by making electrical contact with the corresponding heating connection 23 and 23′ or 25 and 25′, for which purpose electrical lines can run through the corresponding glue hose 5 and 5′ or 15 and 15′. Glue can be heated by a corresponding heating element so that glue is conveyed in the further glue hoses 5 and 5′ as hot glue. For this purpose, the coupling pieces 6 and 6′ are heated via the heating elements.

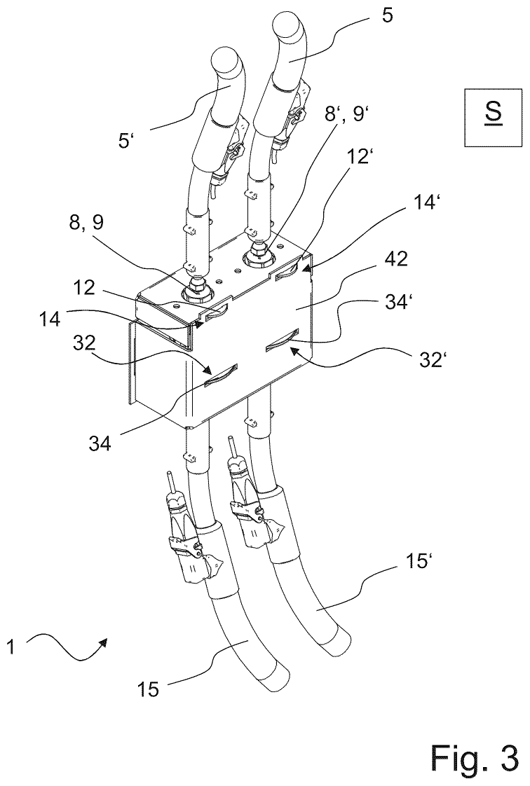

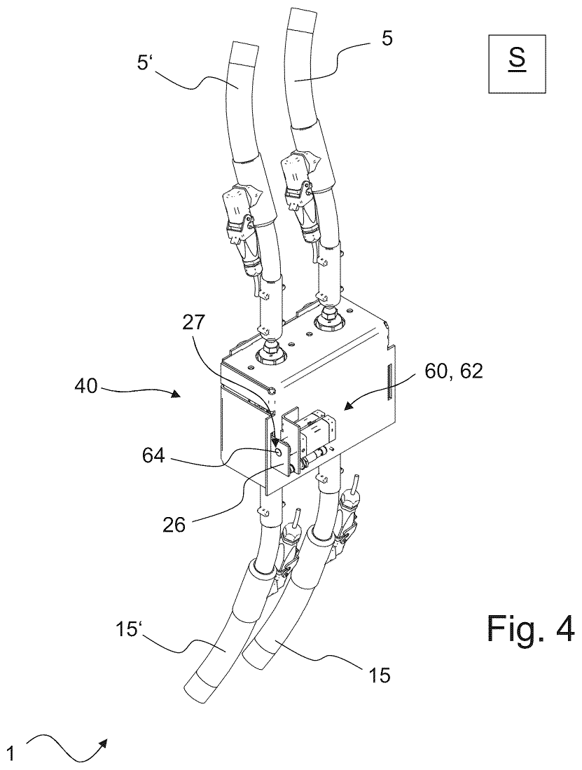

The coupling system 1 comprises a housing 40 formed from two parts 42 and 44. The previously mentioned heating elements can be arranged inside the housing 40 so as to be inaccessible from the outside when the two parts 42 and 44 are joined together, as can be seen in FIGS. 3 and 4. Similarly, the coupling pieces 6 and 6′ are arranged in the housing 40 so as to be inaccessible from the outside when the two parts 42 and 44 are joined together. Advantageously, this eliminates the risk of heating elements or heated coupling pieces 6 and 6′ being inadvertently touched by a user, which could result in injury to the user.

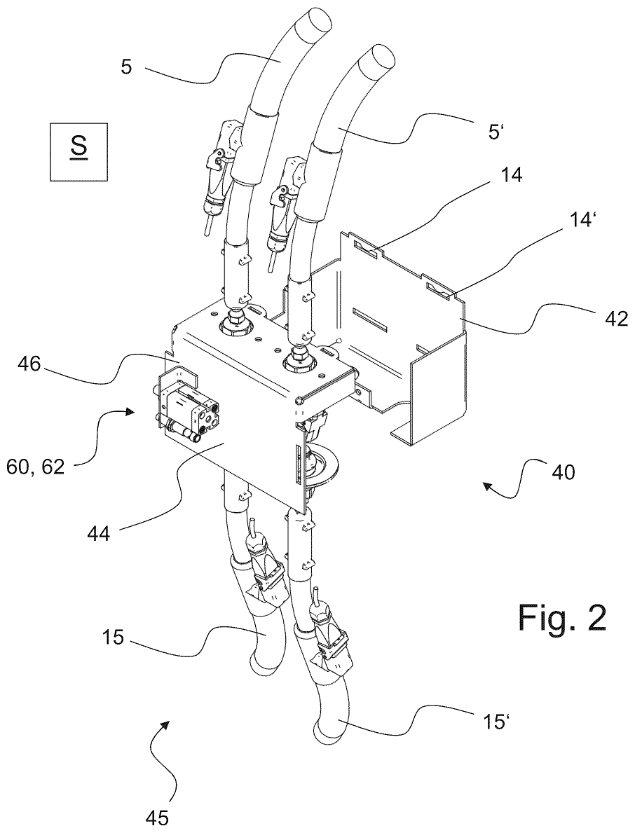

The first part 42 of the housing 40 comprises two openings 32 and 32′ and two slots 14 and 14′. When the two parts 42 and 44 are joined together and the housing 40 is thereby closed, projections 12 and 12′ of the second part 44 are inserted through the slots 14 and 14′. Furthermore, a flap 26 of a lateral housing wall 13 of the first part 42 is inserted into an aperture 16 of the second part 44. The housing 42 is locked or the two parts 42 and 44 are fixed to one another by a locking mechanism 60, which is shown in FIG. 2 and will be described below.

When the two parts 42 and 44 are joined together, retaining rings 34 and 34′ are also positioned in openings 32 and 32′ of the first part 42. The retaining rings 34 and 34′ are part of the mating coupling pieces 18 and 18′, which are attached to the glue hoses 15 and 15′. When the retaining rings 34 and 34′ are located in the openings 32 and 32′ of the first part 42, the mating coupling pieces 18 and 18′ are also held on the first part 42 via the retaining rings 34 and 34′.

The coupling pieces 6 and 6′ can be used to selectively connect several mating coupling pieces 8 and 8′ that lead to spray heads of a labeling apparatus via further hose connections 5 and 5′. If a previously unneeded spray head is to be switched to, a mating coupling piece 8 or 8′, which is arranged on a further hose connection 5 or 5′ of a now needed spray head, is inserted into a coupling piece 6 or 6′. A single gluing device 72 can thus supply a plurality of different spray heads with glue, for which purpose a fluid connection is selectively established between the corresponding spray head and the gluing device 72 via the coupling system 1.

The mating coupling pieces 8 and 8′ are in turn plugs 9 and 9′ that are automatically locked to a corresponding coupling piece 6 and 6′ when a corresponding plug 9 or 9′ is inserted into the corresponding coupling piece 6 or 6′. When the corresponding lock is released, the corresponding mating coupling piece 8 or 8′, together with the corresponding further glue hose 5 or 5′ and the spray head attached thereto, can be removed from the corresponding coupling piece 6 or 6′ and sent for service or transferred to a warehouse or storage facility.

The coupling pieces 6 and 6′, which have a high temperature for heating the glue, are received via the housing 40 so as to be inaccessible from the outside in accordance with the above description. To further reduce the risk of injury, it has been found useful if the connection points of the coupling pieces 6 and 6′ that can be contacted from the outside to insert a plug 9 or 9′ also have thermal insulation.

In the embodiment shown in FIGS. 1 to 4, the coupling system 1 comprises exactly two coupling pieces 6 and 6′. However, it is also conceivable that a coupling system 1 in various embodiments comprises exactly one such coupling piece 6 or 6′ or that a coupling system 1 in various embodiments comprises more than two coupling pieces 6 or 6′.

It is also possible that the glue hoses 15 and 15′ shown in FIG. 1 and/or the further glue hoses 5 and 5′ shown in FIG. 1 have different cross-sectional diameters.

If a coupling system 1 is designed as a component of a gluing machine 70 (cf. FIG. 5), it is possible in this case that the gluing machine 70 comprises precisely one such coupling system 1. It is also possible that a gluing machine 70 comprises several such coupling systems 1.

FIG. 2 shows the embodiment of a coupling system 1 according to FIG. 1, illustrating further aspects. In FIG. 2, the locking mechanism 60 can be seen in particular, which can lock the first part 42 and the second part 44 when the first part 42 and the second part 44 are joined together, as shown in FIGS. 3 and 4. In FIG. 2, the first part 42 and the second part 44 are still separated from each other.

In the embodiment shown, the locking mechanism 60 is designed as a bolt/cylinder unit 62 and is connected to the control device S, which can actuate the locking mechanism 60 to lock the two parts 42 and 44. When the first part 42 and the second part 44 are joined together and the housing 40 is closed, the coupling pieces 6 and 6′, the heating elements and temperature sensors already described are arranged inside the housing 40. The control device S can use the temperature sensors to determine the actual temperature of the coupling pieces 6 and 6′.

The locking mechanism 60 is opened via the control device S only when the actual temperature detected is within a predefined target temperature. This prevents the coupling pieces 6 or 6′ from being contacted unintentionally when they are at a high temperature. There is therefore no risk of injury because the control device S can determine the particular actual temperature of the coupling pieces 6 or 6′ via the temperature sensors and only initiates a release to open the housing 40 via the locking mechanism 60 if the particular actual temperature determined is within the predefined target temperature.

A gluing machine 70 (cf. FIG. 5), which can comprise a coupling system 1 according to the embodiment shown in FIGS. 1 to 4, generally has further sensors that are connected to the control device S and serve safety-relevant aspects. For example, a gluing machine 70 can comprise at least one safety sensor that can detect when a person is in a safety zone in which the coupling system 1 is also arranged. A gluing device 72 or a glue pump of the gluing machine 70 can be connected to the control device S.

If the control device S detects the presence of a person in the safety zone via such a safety sensor, the control device S can automatically depressurize the gluing device 72, as a result of which no glue is pumped through the glue hoses 5 into the coupling system 1. This eliminates the risk of hot glue escaping under pressure from the corresponding glue hose 5 or 5 or 15 or 15′ when the mating coupling pieces 8 and 8′ or 18 and 18′ are separated from the coupling bodies 6 and 6′ and injuring a user due to its temperature.

The safety sensor can be, for example, a camera whose field of view extends into the safety zone. The safety sensor can also be a touch sensor that detects the opening of a door through which a user can enter the safety zone. In addition, there are other safety sensors that are known to a person skilled in the art and are therefore not listed or mentioned in full.

FIG. 3 shows the embodiment of a coupling system 1 according to FIGS. 1 and 2 with a closed and locked housing 40. FIG. 3 is a front view of the housing 40, so that the locking mechanism 60, which is located in the region of a rear side of the housing 40, is not visible in FIG. 3.

As FIG. 3 shows by way of example, the retaining rings 34 and 34′ are now positively engaged in the first part 42 of the housing 40. As already mentioned, the retaining rings 34 and 34′ are part of the mating coupling pieces 18 and 18′ to which the hose connections 15 and 15′ are attached that lead from the coupling system 1 to a gluing device 72 (cf. FIG. 5). FIG. 3 now also shows that the projections 12 and 12′ of the second part 44 of the housing 40 are positioned in the slots 14 of the first part 42 when the housing 40 is closed.

FIG. 4 shows the embodiment of the coupling system 1 from a side opposite the perspective shown in FIG. 3. In FIG. 4, the locking mechanism 60 attached to the second part 44 of the housing 40, which locking mechanism 60 is a bolt/cylinder unit 62, can now be seen again in particular.

When the housing 40 is closed and locked via the locking mechanism 60, a bolt 64 formed as a component of the locking mechanism 60 engages through an opening 27 (cf. also FIG. 1) of the flap 26 of the first part 42. This means that the parts 42 and 44 that form the housing 40 can no longer be separated from each other.

If a user wishes to access the coupling pieces 6 and 6′ located in the housing 40, the bolt 64 must be removed from the opening 27, after which the two parts 42 and 44 can be separated. The control device S is connected both to the locking mechanism 60 and to the temperature sensors arranged in the housing 40. The control device S initiates a retraction movement of the bolt 64 from the opening 27 when the particular temperature of the heated coupling pieces 6 and 6′ determined by the temperature sensors has fallen to such an extent that they have reached a predefined target temperature at which injury to a user can be ruled out.

FIG. 5 shows an embodiment of a packer 50 with an embodiment of a gluing machine 70 according to the invention. Such a packer 50, as shown only by way of example in FIG. 5, comprises a feeder 54 via which several stacks 53, each with several outer packagings, are transported. The outer packagings are removed from the corresponding stack 53 by the feeder 54 and transferred to the buffer 56, which temporarily stores the outer packagings until they are needed to pack beverage containers.

A manipulator positions the individual outer packagings on the horizontal conveyor device 52, which moves the outer packagings in the transport direction TR. The outer packagings can be cardboard boxes, for example, which are used to pack several beverage containers. In the course of transport in the transport direction TR, the glue application format part shown in FIG. 5 with reference numeral 74, which is a spray head, applies glue to a flap of a particular outer packaging. The particular flap is then folded in to close the respective outer packaging. The applied glue then holds the flap in the folded position.

The gluing machine 70, which is provided for applying the glue, comprises a coupling system 1, which further has a housing 40 (cf. FIGS. 1 to 4), not shown in FIG. 5, and comprises a coupling piece 6 or 6′, which is located inside the housing 40. The gluing device 72 of the gluing machine 70 is fluidically connected to the coupling piece 6 or 6′ of the coupling system 1 via a hose connection 15.

In the present case, the gluing machine 70 comprises two different glue application format parts 74 and 76, which are spray heads. Depending on the particular application process provided for applying glue, it may be necessary to apply glue to a flap of the outer packaging either via the glue application format part 76 or via the glue application format part 74.

In the present case, the glue application format part 74 is coupled to the coupling piece 6 or 6′ of the coupling system 1, for which purpose a mating coupling piece 8 or 8′ in the form of a plug 9 or 9′ has been inserted into the coupling piece 6 or 6′, which plug is connected to the further glue hose 5′ of the glue application format part 74. However, the already inserted mating coupling piece 8 or 8′ can be detached from the coupling piece 6 or 6′ so that alternatively the glue application format part 76 can also be inserted into the coupling piece 6 or 6′ via a corresponding mating coupling piece 8 or 8′ connected to the glue hose 5.

Thus, the glue application format parts 74 and 76 can be selectively coupled to the gluing device 72 via the coupling system 1 to supply either the glue application format part 74 or the glue application format part 76 with glue via the gluing device 72.

Further gluing devices 72 are not absolutely necessary to be able to provide glue for several glue application format parts 74 and 76.

The invention has been described with reference to a preferred embodiment. However, it is conceivable for a person skilled in the art that modifications or changes can be made to the invention without departing from the scope of protection of the following claims.

### LIST OF REFERENCE SIGNS

1 coupling system
5 glue hose
5′ glue hose
6 coupling piece
6′ coupling piece
7 coupling sleeve
7′ coupling sleeve
12 projection
12′ projection
13 lateral housing wall
14 slot
14′ slot
15 further glue hose
15′ further glue hose
16 aperture
18 mating coupling piece
18′ mating coupling piece
19 plug
19′ plug
23 heating connection
23′ heating connection
25 heating connection
25′ heating connection
26 flap
27 opening
32 opening
32′ opening
34 retaining ring
34′ retaining ring
40 housing
42 first part
44 second part
46 rear housing wall
50 packer
52 horizontal conveyor device
54 feeder
56 buffer
60 locking mechanism
62 bolt/cylinder unit
70 gluing machine
72 gluing device
74 glue application format part
76 glue application format part
80 packer
S control device
TR transport direction

1. A coupling system (1) for fluid connection of glue hoses (5, 5′, 15, 15′) comprising:
a housing (40) and
at least one coupling piece (6, 6′) that can be fastened to a glue hose (15, 15′) of a gluing device (72), that is received by the housing (40), and that can be selectively and detachably coupled to mating coupling pieces (8, 8′) of several further glue hoses (5, 5′) connected to different glue application format parts (74, 76) so that a fluid connection is formed between the corresponding glue hose (15, 15′) and the corresponding further glue hose (5, 5′) via the coupling piece (6, 6′) and the mating coupling piece (8, 8′).

2. The coupling system (1) of claim 1, wherein the at least one coupling piece (6, 6′) forms a coupling body into which a corresponding mating coupling piece (8, 8′), designed as a plug (9, 9′), can be inserted.

3. The coupling system (1) of claim 2, wherein the at least one coupling piece (6, 6′) automatically locks the corresponding mating coupling piece (8, 8′) upon insertion into the coupling body.

4. The coupling system (1) of claim 1, further comprising at least one heating element that controls the temperature of the at least one coupling piece (6, 6′), wherein the at least one heating element is located in the housing (40).

5. The coupling system (1) claim 1, wherein the housing (40) is formed from at least two corresponding parts (42, 44) that house the at least one coupling piece (6, 6′) inaccessibly from the outside when the at least two corresponding parts (42, 44) are joined together and that are separable such that the at least one coupling piece (6, 6′) can be accessed by separating the at least two corresponding parts (42, 44).

6. The coupling system (1) of claim 5, further comprising a releasable locking mechanism (60) that locks the at least two corresponding parts (42, 44) when they are joined together.

7. The coupling system (1) of claim 6, wherein the locking mechanism (60) is a bolt/cylinder unit (62).

8. A gluing machine (70) comprising:
at least one gluing device (72) having at least one glue hose (15, 15′),
multiple glue application format parts (74, 76) each having a corresponding further glue hose (5, 5′), each of the glue application format parts (74, 76) being designed for dispensing glue,
at least one coupling system (1) having a housing (40) and at least one coupling piece (6, 6′), which at least one coupling piece (6, 6′) is housed within the housing (40) and is fluidically connected to the at least one glue hose (15, 15′), wherein the multiple further glue hoses (5, 5′) each comprise a mating coupling piece (8, 8′) and wherein the at least one coupling piece (6, 6′) can be selectively and detachably coupled to the mating coupling pieces (8, 8′) so that a fluid connection is formed between the corresponding glue hose (15, 15′) and the corresponding further glue hose (5, 5′) via the coupling piece (6, 6′) and the mating coupling piece (8, 8′) coupled to the coupling piece (6, 6′).

9. The gluing machine (70) of claim 8, wherein the at least one coupling piece (6, 6′) forms a coupling body and the mating coupling pieces (6, 6′) are designed as plugs (9, 9′) that can be inserted into the coupling body for the corresponding coupling with the coupling body.

10. The gluing machine (70) of claim 9, wherein the at least one coupling piece (6, 6′) automatically locks the corresponding mating coupling piece (8, 8′) upon insertion into the coupling body.

11. The gluing machine (70) of claim 8, wherein the coupling system (1) further comprises at least one heating element that controls the temperature of the at least one coupling piece (6, 6′), wherein the at least one heating element is located in the housing (40) of the coupling system (1).

12. The gluing machine (70) of claim 11, further comprising a locking mechanism (60) that locks the housing (40).

13. The gluing machine (70) of claim 12, further comprising at least one temperature sensor to determine an actual temperature of the at least one coupling piece (6, 6′), wherein the at least one temperature sensor and the locking mechanism (60) are operatively connected to one another so that release of the locking mechanism (60) is prevented if the determined actual temperature determined is above a target temperature.

14. The gluing machine (70) of claim 13, wherein the coupling system (1) is arranged within a defined safety zone of the gluing machine (70) and wherein the gluing machine (70) further comprises at least one safety sensor by which a presence of a person in the safety zone can be detected, wherein the at least one safety sensor and the gluing device (72) are operatively connected to one another such that glue is prevented from being conveyed by the gluing device (72) when the presence of a person in the safety zone is detected by the at least one safety sensor.

15. (canceled)

16. (canceled)

17. A method for operating a gluing machine (70), comprising:
providing a gluing device (72) having at least one glue hose (15, 15′);
providing a coupling system (1), having a housing (40), in which at least one coupling piece (6, 6′) is located, wherein the coupling system (1) is attached to the at least one glue hose (15, 15′);
providing at least several different glue application format parts (74, 76), each of which has a further hose connection (5, 5′) having a corresponding mating coupling piece (8, 8′);
selecting a particular glue application format part (74, 76) from the several different glue application format parts (74, 76), and
selectively and detachably coupling the coupling piece (6, 6′) to the mating coupling piece (8, 8′) of the further hose connection (5, 5′) of the selected glue application format part (74, 76), which is accompanied by a fluid connection being formed between the corresponding glue hose (15, 15′) of the gluing device (72) and the corresponding further glue hose (5, 5′) of the corresponding selected glue application format part (74, 76) via the coupling piece (6, 6′) and the mating coupling piece (8, 8′) coupled to the coupling piece (6, 6′).

18. The method of claim 17, wherein the coupling system (1) has a locking mechanism (60) via which the housing (40) is locked and wherein a particular actual temperature of the coupling piece (6, 6′) is determined via a temperature sensor, wherein the temperature sensor and the locking mechanism interact so that the locking is maintained when the actual temperature is above a predefined target temperature.
